(19) United States
(12) Patent Application Publication
(10) Pub. No.: US 2012/0003980 A1
(43) Pub. Date: Jan. 5, 2012

(54) METHOD AND APPARATUS FOR SUPPORTING LOCAL BREAKOUT IN WIRELESS COMMUNICATION NETWORK INCLUDING FEMTOCELLS

(75) Inventors: Chae Gwon Lim, Seoul (KR); Kyung Joo Suh, Seoul (KR); Sung Ho Choi, Gyeonggi-do (KR); Beom Sik Bae, Gyeonggi-do (KR); Song Yean Cho, Seoul (KR); Han Na Lim, Seoul (KR)

(73) Assignee: SAMSUNG ELECTRONICS CO., LTD., Suwon-city, Gyeonggi-do (KR)

(21) Appl. No.: 13/203,064

(22) PCT Filed: Feb. 24, 2010
(86) PCT No.: PCT/KR10/01139

§ 371 Date: Sep. 14, 2011

(30) Foreign Application Priority Data
Feb. 24, 2009 (KR) 10-2009-0015447

(51) Int. Cl. H04W 40/00

(52) U.S. Cl. 455/445

(57) ABSTRACT

A method and apparatus for supporting local breakout (LBO) in a wireless communication network including femtocells are disclosed. The method includes: sending, by a user equipment, a PDN connectivity request message to a femtocell base station, for setting up an LBO bearer toward a data network different from the core network; forwarding, by the femtocell base station, the PDN connectivity request message to a femto mobility management entity managing LBO bearer setup; and setting up, by the femto mobility management entity, an LBO bearer between the user equipment and the data network by establishing a connection between the user equipment and a femto PDN gateway.

### TECHNICAL FIELD

The present invention relates generally to local breakout in a wireless communication network including femtocells and, more particularly, to a method and apparatus for supporting local breakout (LBO) in a wireless communication network including femtocells wherein a user equipment connected to a femtocell base station can directly transmit data to a data network without going through the core network.

### BACKGROUND ART

A femtocell is an indoor cell in a home or office managed by a miniaturized base station that is connected through a broadband link to the core of a mobile communication network. Femtocells may contribute to extension of indoor cell coverage, enhancement of radio signal quality, and effective delivery of wired and wireless convergence services.

In 3GPP LTE (Long Term Evolution), two types of base stations eNB (evolved NodeB) and HeNB (home evolved NodeB) are defined. The eNB is a macro base station managing a regular macro cell, and the HeNB is a femtocell base station.

That is, the 3GPP standard considers a communication environment in which macro cells coexist with femtocells to which only registered subscribers can connect. In such an environment, a femtocell may be deployed by a user or an operator for enlargement of coverage and capacity and delivery of differentiated services. A femtocell may have a coverage of several meters, and may be extended to a coverage comparable to that of a macro cell.

### DISCLOSURE OF INVENTION

### Technical Problem

However, though a user equipment connected to a femtocell may directly access a data network, it may have to access the data network through a transmission path involving the corresponding femtocell base station and the core network including a serving gateway and a packet data network gateway.

Hence, it is necessary to provide a local breakout (LBO) facility that enables a user equipment connected to a femtocell to directly transmit data to a data network without going through the core network.

### Solution to Problem

The present invention has been made in view of the above problems, and the present invention provides a wireless communication network and a method that provide a local breakout facility to a user equipment connected to a femtocell for efficient data transmission.

In accordance with an exemplary embodiment of the present invention, there is provided a method for supporting local breakout (LBO) in a wireless communication network including femtocells, including: sending, by a user equipment, a PDN connectivity request message to a femtocell base station, for setting up an LBO bearer toward a data network different from the core network; forwarding, by the femtocell base station, the PDN connectivity request message to a femto mobility management entity managing LBO bearer setup; and setting up, by the femto mobility management entity, an LBO bearer between the user equipment and the data network by establishing a connection between the user equipment and a femto PDN gateway.

In accordance with another exemplary embodiment of the present invention, there is provided a method for supporting local breakout (LBO) in a wireless communication network including femtocells, including: receiving, by a femtocell base station, LBO information for setting up an LBO bearer toward a data network different from the core network; notifying, by the femto PDN gateway after receiving data to be sent to a user equipment from the data network, a femto mobility management entity controlling LBO bearer setup of data reception; and paging, by the femtocell base station upon receiving a paging command from the femto mobility management entity, the user equipment utilizing the received LBO information.

In accordance with another exemplary embodiment of the present invention, there is provided a femtocell supporting local breakout (LBO) in a wireless communication network, including: a femtocell base station identifying, when a PDN connectivity request message from a user equipment for setting up an LBO bearer toward a data network different from the core network, a destination of the PDN connectivity request message and forwarding the same to the destination; a femto mobility management entity controlling LBO bearer setup, receiving a PDN connectivity request message, and establishing a connection to setup an LBO bearer between the user equipment and the data network; and a femto PDN gateway connecting the user equipment and the data network through the LBO bearer.

### Advantageous Effects of Invention

In a feature of the present invention, a user equipment connected to a femtocell may directly transmit data to a data network without going through the core network. Hence, the user equipment may perform efficient data transmission.

### BRIEF DESCRIPTION OF DRAWINGS

The features and advantages of the present invention will be more apparent from the following detailed description in conjunction with the accompanying drawings, in which:

FIG. 1 illustrates a wireless communication network including both macro cells and femtocells according to an exemplary embodiment of the present invention;

FIGS. 2 to 4 illustrate configurations of a femtocell base station supporting LBO;

FIG. 5 is a sequence diagram illustrating transmission of LBO information from a mobility management entity (MME) of the core network to a femtocell base station;

FIG. 6 is a sequence diagram illustrating transmission of an LBO related NAS (Non-Access Stratum) message from a user equipment to a femto MME;

FIG. 7 is a flow chart illustrating a procedure for a femtocell base station to determine the target MME for a received NAS message;

FIG. 8 is a sequence diagram illustrating a procedure for a user equipment to send an LBO request through a femtocell base station and to access a data network through LBO; and

FIG. 9 is a sequence diagram illustrating a procedure for a femtocell base station to forward data from a data network to a user equipment in idle mode.

### MODE FOR THE INVENTION

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

The terminology used in the description is primarily based on the 3GPP LTE system specification. However, the present invention is not limited thereto.

The terms “cell” and “base station” may be used interchangeably without much confusion. Hence, in the description, the words “macro cell” and “macro-cell base station” may be used interchangeably; and the words “femtocell” and “femtocell base station” may be used interchangeably.

“Local breakout (LBO)” relates to a facility that enables a user equipment (UE) to directly use a service from a data network without going through the core network.

A “data network” refers to any network differing from the core network of a network operator, and may be managed by an organization other than the network operator. A data network may be the Internet or a service network.

First, a description is given of a wireless communication network. The wireless communication network is based on a cellular system in which macro-cell base stations coexist with femtocell base stations.

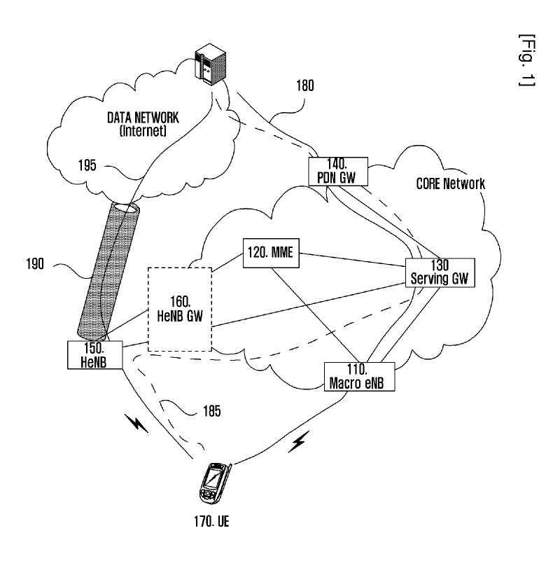

FIG. 1 illustrates a wireless communication network including both macro cells and femtocells according to an exemplary embodiment of the present invention. The wireless communication network may include a macro-cell base station (macro eNB) 110, a mobility management entity (MME) 120, a serving gateway 130, a PDN gateway 140, a femtocell base station (HeNB) 150, a femtocell base station gateway (HeNB GW) 160, and a user equipment (UE) 170.

The macro-cell base station 110 is a base station that manages a macro cell, which may refer to a regular cellular system cell. For the purpose of description, the words “macro cell” and “macro-cell base station” may be used interchangeably.

The macro-cell base station 110 may be connected to the user equipment 170 through a wireless channel, and manage radio resources. For example, the macro-cell base station 110 may broadcast control information necessary for the macro cell as system information, and may allocate radio resources necessary for transmitting and receiving data or control information to and from the user equipment 170. The macro-cell base station 110 may also collect channel measurement results related to the current cell and neighbor cells from the user equipment 170, make a handover decision, and send a handover command to the user equipment 170 if necessary. To achieve this, the macro-cell base station 110 may be equipped with control protocols related to radio resource management, such as the Radio Resource Control protocol.

The mobility management entity 120 manages a user equipment in idle mode, and may select a serving gateway and a PDN gateway. The mobility management entity 120 may also perform operations related to roaming and authentication. The mobility management entity 120 may process a bearer signal generated from the user equipment 170. In particular, the mobility management entity 120 may deliver LBO information (paging information and/or LBO feature information) to the femtocell base station 150.

The serving gateway 130 may act as a mobility anchor when the user equipment 170 performs handover between base stations or roams between 3GPP radio networks.

The PDN (packet data network) gateway 140 may allocate an IP address to the user equipment 170, performs operations related to packet data of the core network, and act as a mobility anchor when the user equipment 170 travels between 3GPP and non-3GPP radio networks. The PDN gateway 140 may also determine a bearer frequency provided to a specific subscriber, and forward and route packet data.

The femtocell base station 150 is connected to the mobility management entity 120 of the core network through a radio network controller (not shown) to provide mobile communication services to the user equipment 170. A femtocell is normally termed as a closed subscriber group (CSG) cell, which only a group of pre-registered subscribers may access. CSG cells are typically deployed as a small indoor cell in a home, and may also be deployed in a large office. The femtocell base station 150 provides mobile communication services only to registered user equipments, and broadcasts a system information block (SIB) containing identification information (CSG ID) of the group of registered subscribers.

The femtocell base station gateway 160 connects the mobility management entity 120 with the femtocell base station 150, and may be included in another entity depending on the design.

The user equipment 170 may connect to the core network through the macro-cell base station 110 or through the femtocell base station 150.

When connected to the macro-cell base station 110, the user equipment 170 may access the data network through a data transmission path 180 involving the macro-cell base station 110, the serving gateway 130 and the PDN gateway 140.

When connected to the femtocell base station 150, the user equipment 170 may access the data network through a data transmission path 185 involving the femtocell base station 150, the serving gateway 130 and the PDN gateway 140. However, the data transmission path 185 may be a roundabout route going through the core network to the data network in comparison to a direct transmission path 190 from the femtocell base station 150 to the data network. In the present invention, for more efficient data transmission, an LBO feature is provided to the user equipment 170 connected to the femtocell base station 150.

Next, a description is given of a femtocell base station supporting LBO. The terms “cell” and “base station” may be used interchangeably without much confusion.

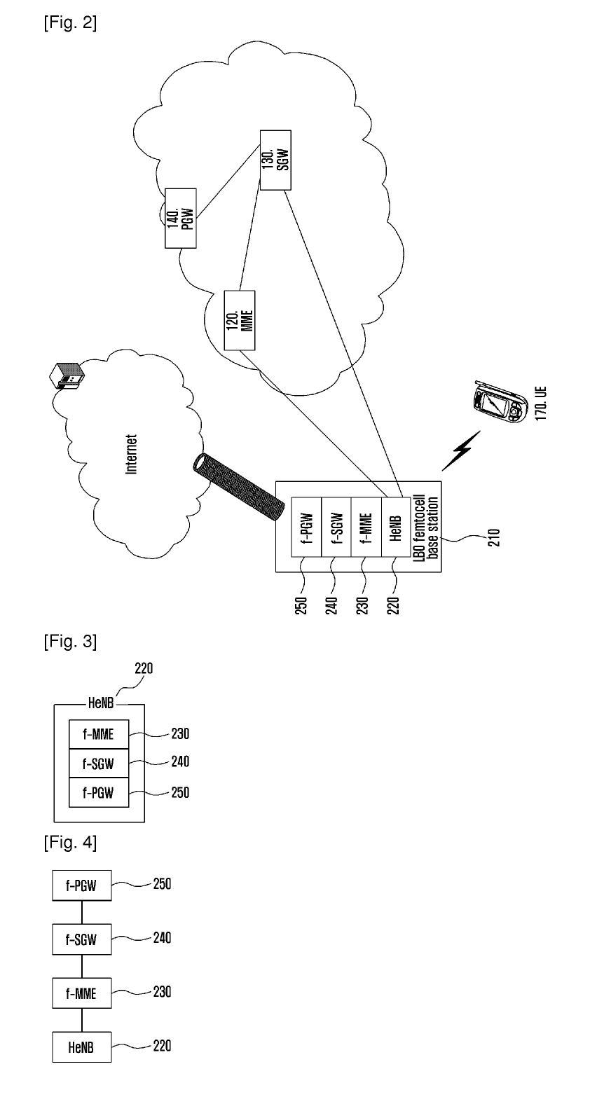

FIG. 2 illustrates a femtocell base station 210 supporting LBO (hereinafter, referred to as an LBO femtocell base station 210). The LBO femtocell base station 210 may include functional blocks such as a femtocell base station (HeNB) 220, a femto mobility management entity (f-MME) 230, a femto serving gateway (f-SGW) 240, and a femto PDN gateway (f-PGW) 250.

The LBO femtocell base station 210 can be configured in various ways. For example, the LBO femtocell base station 210 is configured to include other functional blocks in FIG. 2. As shown in FIG. 3, the femtocell base station 220 may be configured to include other functional blocks. In FIG. 4, the functional blocks are connected together as in the case of the core network. In FIG. 4, the femto mobility management entity (f-MME) 230 is an entity operating independently of the mobility management entity (MME) 120 of the core network. Hence, in the present invention, different types of mobility management entities may coexist in the network, and the user equipment 170 may selectively communicate with one of the different mobility management entities.

Here, the femtocell base station 220, the femto serving gateway 240 and the femto PDN gateway (f-PGW) 250 may correspond respectively to the femtocell base station 150, the serving gateway 130 and the PDN gateway 140 described in connection with FIG. 1. Hence, repeated descriptions are not provided.

The femtocell base station 220 may receive a Non-Access Stratum (NAS) message from the user equipment 170, and selectively forward the NAS message to one of the mobility management entity 120 of the core network and the femto mobility management entity 230. This is further described later.

The femtocell base station 220 may receive LBO information from the mobility management entity 120. The LBO information may be used to page a user equipment in idle mode.

The femto mobility management entity 230 may page a user equipment in idle mode, and may perform LBO bearer management and control for LBO bearer creation, change, and release.

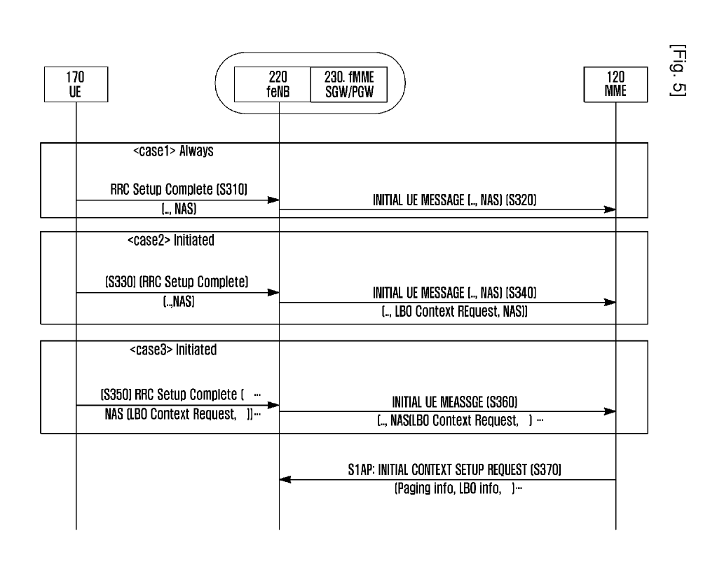

FIG. 5 is a sequence diagram illustrating transmission of LBO information from the mobility management entity 120 of the core network to the femtocell base station 220.

The LBO information may include UE paging information and LBO feature information. The UE paging information may include at least one of a UE ID index and a UE specific paging DRX (discontinuous reception) cycle. The LBO feature information may include LBO bearer QoS parameters.

Referring to FIG. 5, the mobility management entity 120 of the core network may send LBO information to the femtocell base station 220 according to the following three cases. In the first case, when a message containing UE information is sent for the first time, the mobility management entity 120 sends LBO information together with the message to the femtocell base station 220. In the second case, the mobility management entity 120 sends LBO information in response to a request from the femtocell base station 220. In the third case, the mobility management entity 120 sends LBO information in response to a request from the user equipment 170.

To be more specific for the first case, upon completion of radio resource control (RRC) setup, the user equipment 170 sends an RRC setup complete message to the femtocell base station 220 (S310). Upon reception of the RRC setup complete message, the femtocell base station 220 sends an S1AP initial UE message to the mobility management entity 120 (S320). Here, “S1AP” indicates a message going from the base station level to the core level. Upon reception of the initial UE message, the mobility management entity 120 sends an initial context setup request message containing UE paging information and LBO feature information to the femtocell base station 220 (S370).

For the second case, upon completion of RRC setup, the user equipment 170 sends an RRC setup complete message to the femtocell base station 220 (S330). The femtocell base station 220 may request LBO information from the mobility management entity 120 if necessary by sending a separate UE LBO context request message to the mobility management entity 120 or by piggybacking a UE LBO context request indicator on another message going to the mobility management entity 120 (S340). Upon reception of the LBO context request, the mobility management entity 120 sends an initial context setup request message containing UE paging information and LBO feature information to the femtocell base station 220 (S370).

For the third case, upon completion of RRC setup, the user equipment 170 sends an RRC setup complete message to the femtocell base station 220 (S350). The user equipment 170 may request LBO information from the mobility management entity 120 by sending a separate NAS UE LBO context request message to the mobility management entity 120 or by piggybacking a UE LBO context request indicator on another message going to the mobility management entity 120 (S360). Here, NAS (non access stratum) indicates a message going from the UE level to the core level. Upon reception of the LBO context request, the mobility management entity 120 sends an initial context setup request message containing UE paging information and LBO feature information to the femtocell base station 220 (S370).

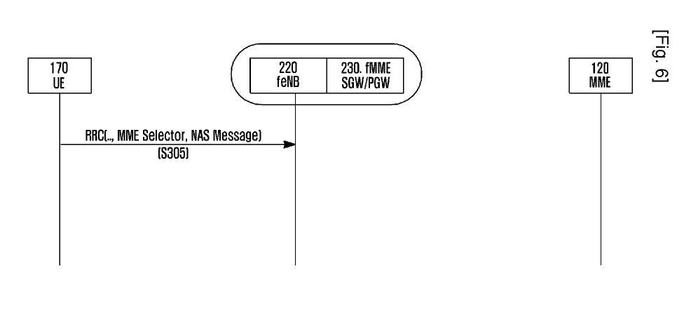

FIG. 6 is a sequence diagram illustrating transmission of an LBO related NAS message from the user equipment 170 to the femto mobility management entity 230.

Referring to FIG. 6, the user equipment 170 adds an MME selector parameter to an

RRC message going to the femtocell base station 220. Here, the MME selector parameter indicates a selection made by the user equipment 170 for a particular one of the different mobility management entities. The user equipment 170 sends the RRC message containing a NAS message to the femtocell base station 220 (S410). Hence, the femtocell base station 220 may select one of the mobility management entity 120 in the core network and the femto mobility management entity 230 to which it has to send the NAS message. Next, selection of a mobility management entity is described in detail.

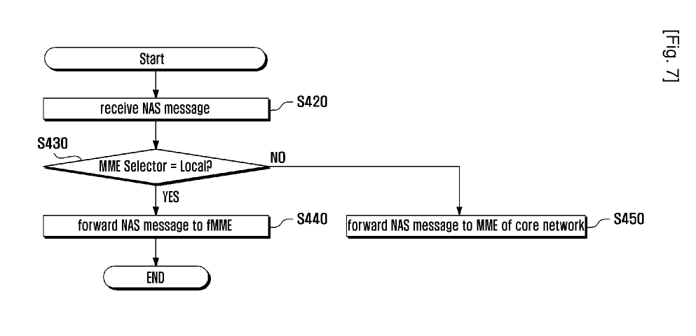

FIG. 7 is a flow chart illustrating a procedure for the femtocell base station 220 to determine the target MME for a received NAS message.

Referring to FIG. 7, the femtocell base station 220 receives a NAS message as part of an RRC message (S420). The femtocell base station 220 checks whether the MME selector of the RRC message is set to “local” (S430).

If the MME selector is set to “local”, the femtocell base station 220 forwards the NAS message to the femto mobility management entity 230 (S440). If the MME selector is not set to “local”, the femtocell base station 220 forwards the NAS message to the mobility management entity 120 of the core network (S450).

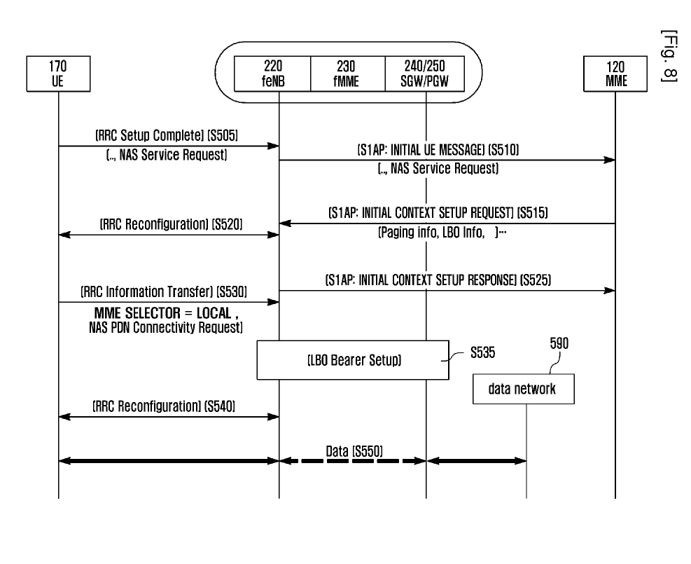

FIG. 8 is a sequence diagram illustrating a procedure for the user equipment 170 to send an LBO request through the femtocell base station 220 and to access a data network 590 through LBO. Here, the data network 590 may be an IP based network, a home network or a private network that is managed by an organization other than the operator of the core network.

FIG. 8 depicts that the mobility management entity 120 of the core network sends UE paging information and LBO feature information to the femtocell base station 220 according to the first case described in FIG. 5. A person skilled in the art may readily understand that the second case and the third case described in FIG. 5 are also applicable here.

Referring to FIG. 8, upon completion of RRC setup with the femtocell base station 220, the user equipment 170 sends a NAS service request message to the femtocell base station 220 for radio bearer creation toward the core network (S505). The femtocell base station 220 sends an S1AP initial UE message containing the NAS service request message to the mobility management entity 120 of the core network (S510).

The mobility management entity 120 sends an S1AP initial context setup request message containing UE paging information and LBO feature information to the femtocell base station 220 (S515). The femtocell base station 220 and the user equipment 170 perform RRC reconfiguration (S520), and the femtocell base station 220 sends an SLAP initial context setup response message to the mobility management entity 120 (S525). Bearer formation is completed through steps S520 and S525 for data communication between the user equipment 170 and the core network.

Thereafter, for bearer formation toward the data network 590, the user equipment 170 sends a NAS PDN connectivity request message for LBO as part of an RRC message to the femtocell base station 220 (S530). Here, the NAS PDN connectivity request message is used for bearer formation between the data network 590 and the femto PDN gateway 250. The user equipment 170 sets the MME selector of the RRC message to “local”.

After checking the MME selector set to “local”, the femtocell base station 220 forwards the NAS PDN connectivity request message to the femto mobility management entity 230 (not to the mobility management entity 120 of the core network). The femto mobility management entity 230 establishes a connection between the user equipment 170 and the femto PDN gateway 250 (S535). Thereby, LBO bearer formation is completed for data communication between the user equipment 170 and the data network 590.

The user equipment 170 performs bearer update through RRC reconfiguration with the femtocell base station 220 (S540). Here, the femto mobility management entity 230 may send an LBO specific NAS message to the user equipment 170.

After completion of above steps, the user equipment 170 may directly send and receive data to and from the data network 590 without going through the core network (S550). Here, the bearer between the user equipment 170 and the core network has a unique bearer ID different from that of the bearer between the user equipment 170 and the data network 590. Hence, the femtocell base station 220 may distinguish data going to the core network from data going to the data network 590 on the basis of bearer IDs.

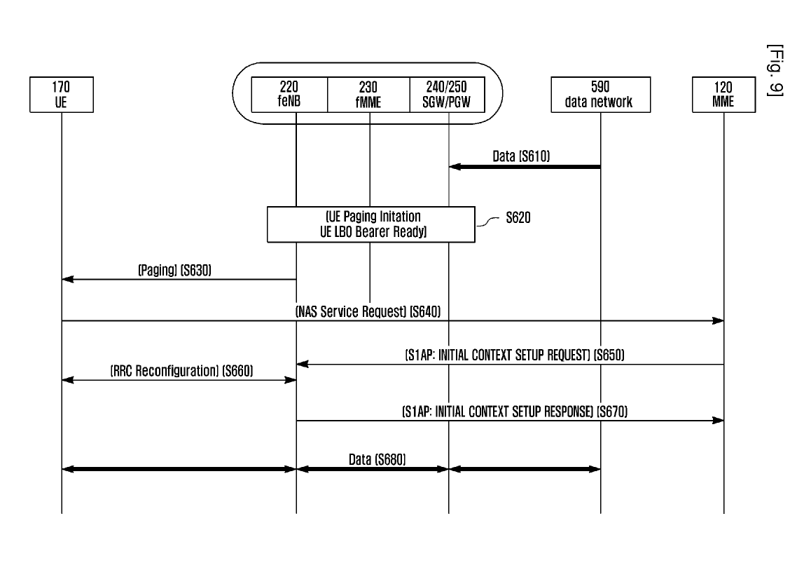

FIG. 9 is a sequence diagram illustrating a procedure for the femtocell base station 220 to forward data from the data network 590 to the user equipment 170 in idle mode.

When the user equipment 170 enters idle mode after setup of an LBO bearer, the LBO bearer is released. Hence, when data to be sent from the data network 590 to the user equipment 170 is present, it is necessary to setup an LBO bearer.

Referring to FIG. 9, the femto PDN gateway 250 receives data from the data network 590 (S610). The femto PDN gateway 250 notifies the femto mobility management entity 230 of the presence of data to be sent to the user equipment 170. The femto mobility management entity 230 issues a request for UE paging and LBO bearer setup to the femtocell base station 220 (S620). As it can be known of the UE ID index and the UE specific paging DRX value from the UE paging information received at step S515, the femtocell base station 220 can page the user equipment 170.

The femtocell base station 220 pages the user equipment 170 (S630). In this case, the user equipment 170 may not know which of the mobility management entity 120 and the femto mobility management entity 230 has paged it. The user equipment 170 sends a NAS service request message to the mobility management entity 120 of the core network (S640). The mobility management entity 120 sends an S1AP initial context setup request message to the femtocell base station 220 for bearer setup as to the core network (S650).

The femtocell base station 220 performs radio bearer setup for the user equipment 170 through RRC reconfiguration (S660). Here, the femtocell base station 220 performs radio bearer setup for both the bearer between the user equipment 170 and the core network and the LBO bearer between the user equipment 170 and the data network 590. The femtocell base station 220 sends an S1AP initial context setup response message to the mobility management entity 120, notifying UE context setup completion (S670).

Thereafter, the user equipment 170 may receive data from the data network 590 through the newly set bearer (S680).

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

1. A method for supporting local breakout (LBO) in a wireless communication network including femtocells, comprising: sending, by a user equipment, a PDN connectivity request message to a femtocell base station, for setting up an LBO bearer toward a data network different from the core network; forwarding, by the femtocell base station, the PDN connectivity request message to a femto mobility management entity managing LBO bearer setup; and setting up, by the femto mobility management entity, an LBO bearer between the user equipment and the data network by establishing a connection between the user equipment and a femto PDN gateway.

2. The method of claim 1, further comprising: selecting, by the user equipment, a femto mobility management entity managing LBO bearer setup from multiple mobility management entities before sending a PDN connectivity request message; and making, by the user equipment, a setting so that the PDN connectivity request message is sent to the selected femto mobility management entity.

3. The method of claim 1, further comprising receiving, by the femtocell base station, LBO information for LBO bearer setup from a mobility management entity of the core network before sending a PDN connectivity request message.

4. The method of claim 3, wherein the LBO information is sent from the mobility management entity of the core network to the femtocell base station in response to a request from the femtocell base station.

5. The method of claim 3, wherein the LBO information is sent from the mobility management entity of the core network to the femtocell base station in response to a request from the user equipment.

6. The method of claim 3, wherein the LBO information comprises at least one of UE paging information and LBO feature information.

7. The method of claim 6, wherein the UE paging information comprises at least one of a UE ID index and a UE specific paging DRX value, and the LBO feature information comprises LBO bearer QoS parameters.

8. The method of claim 3, further comprising: paging, when data to be sent to the user equipment is present in the data network, by the femtocell base station, the user equipment in idle mode; and setting up, by the paged user equipment, a new LBO bearer.

9. The method of claim 8, wherein paging the user equipment in idle mode comprises: notifying, by the femto PDN gateway after receiving the data to be sent to the user equipment, the femto mobility management entity of data reception; and paging, by the femtocell base station after receiving a paging command from the femto mobility management entity, the user equipment in idle mode.

10. The method of claim 9, wherein setting up a new LBO bearer comprises: sending, by the user equipment, a service request message to the mobility management entity of the core network; and performing, by the femtocell base station after receiving an initial context setup request message from the mobility management entity of the core network, LBO bearer setup for the user equipment through RRC reconfiguration.

11. The method of claim 1, further comprising performing, by the user equipment, radio bearer setup toward the core network.

12. A method for supporting local breakout (LBO) in a wireless communication network including femtocells, comprising: receiving, by a femtocell base station, LBO information for setting up an LBO bearer toward a data network different from the core network; notifying, by the femto PDN gateway after receiving data to be sent to a user equipment from the data network, a femto mobility management entity controlling LBO bearer setup of data reception; and paging, by the femtocell base station upon receiving a paging command from the femto mobility management entity, the user equipment utilizing the received LBO information.

13. The method of claim 12, wherein the LBO information is sent from a mobility management entity of the core network to the femtocell base station in response to a request from the femtocell base station.

14. The method of claim 12, wherein the LBO information is sent from a mobility management entity of the core network to the femtocell base station in response to a request from the user equipment.

15. The method of claim 12, wherein the LBO information comprises at least one of UE paging information and LBO feature information.

16. A femtocell supporting local breakout (LBO) in a wireless communication network, comprising: a femtocell base station identifying, when a PDN connectivity request message from a user equipment for setting up an LBO bearer toward a data network different from the core network, a destination of the PDN connectivity request message and forwarding the same to the destination; a femto mobility management entity controlling LBO bearer setup, receiving a PDN connectivity request message, and establishing a connection to setup an LBO bearer between the user equipment and the data network; and a femto PDN gateway connecting the user equipment and the data network through the LBO bearer.

17. The femtocell supporting LBO of claim 16, wherein the femtocell base station receives LBO information for LBO bearer setup from a mobility management entity of the core network.

18. The femtocell supporting LBO of claim 17, wherein the LBO information is sent from the mobility management entity of the core network to the femtocell base station in response to a request from the femtocell base station.

19. The femtocell supporting LBO of claim 17, wherein the LBO information is sent from the mobility management entity of the core network to the femtocell base station in response to a request from the user equipment.

20. The femtocell supporting LBO of claim 17, wherein, when data to be sent to the user equipment in idle mode is present in the data network, the femto mobility management entity requests the femtocell base station to page the user equipment, and the femtocell base station pages the user equipment utilizing received LBO information and sets up a new LBO bearer together with the paged user equipment through RRC reconfiguration.
